(19) United States
(12) Patent Application Publication
(10) Pub. No.: US 2002/0078170 A1
(43) Pub. Date: Jun. 20, 2002

(54) Method and system for minimizing network bandwidth bottlenecks

(75) Inventors: James A. Brewer, Leander, TX (US); Sanjay Gupta, Austin, TX (US); Mark Alan Jacks, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation

(21) Appl. No.: 09/737,343

(22) Filed: Dec. 15, 2000

(51) Int. Cl. G06F 15/16

(52) U.S. Cl. 709/218; 709/219

(57) ABSTRACT

A method and system for reducing network traffic in a data processing network are disclosed. The data processing system typically includes a user station, a boot server from which portions of the user station operating system are retrieved, and an application server from which portions of a user application program are retrieved. In one embodiment, a user station of the data processing system includes a non-volatile storage device. Portions of the operating system and application that are frequently accessed may be downloaded from the appropriate servers and stored in the non-volatile storage device. In one embodiment, the user station may determine which code segments constitute key code segments by recording page fault in a miss table of the user station. The most frequently accessed pages can then be determined for storing in local memory. To maintain consistency of software when the operating system or an application program is revised or updated, one embodiment of the invention clears the key code segments from all local non-volatile storage devices when an operating system or application program is newly installed on one of the servers. In another embodiment, network traffic is reduced by installing a program on the user station and the data server that monitor changes to a data file. When an application is invoked by the user station and the user begins to modify data, the user station program records the changes that are made to the data file locally in a local change file. Periodically the local change file is transferred to the data server, where the local changes are incorporated into a master change file on the data server. When the user ultimately exits the program or saves the data, the server program reads the master change file and implements the changes to the data file.

### BACKGROUND

1. Field of the Present Invention

The present invention generally relates to the field of computer networks and more particularly to a method and system that reduce network traffic and distribute network traffic over time to minimize bottlenecks caused by limited system bandwidth.

2. History of Related Art

Computer networks have proliferated rapidly and are now encountered in almost every type of data processing application. In a computer network, two or more computing devices are linked together over a transmission media. Suitable transmission media can include twisted wire pairs, coaxial cables, optical fibers, and wireless media. All such transmission media are characterized by a finite ability to transmit data among the devices that comprise the network, i.e., finite bandwidth. Efforts to improve network bandwidth capacity include the use of high bandwidth transmission media such as fiber optic cable and sophisticated data compression software. Typically, however, implementing a new transmission medium or new compression software entails the expenditure of significant resources including the capital required to obtain the resources and the engineering and support services to install, debug, and maintain it. Moreover, the demand for bandwidth may eventually exceed a network's capacity regardless of attempts to improve bandwidth capacity. It is, therefore, universally desirable to minimize the bandwidth requirements of an existing network. It is further desirable if a given solution for reducing bandwidth consumption is economical, compatible with existing software, and relatively easy to install and administer.

### SUMMARY OF THE INVENTION

The problems identified above are in large part addressed by a method and system for reducing network traffic in a data processing network. The data processing system typically includes a user station, a boot server from which portions of the user station operating system are retrieved, and an application server from which portions of a user application program are retrieved. In one embodiment, a user station of the data processing system includes a nonvolatile storage device. Portions of the operating system and application program that are frequently accessed may be downloaded from the appropriate servers and stored in the nonvolatile storage device. By storing these frequently accessed or “key” code segments in the nonvolatile device, the user station can fetch these segments locally and store them into the user station system memory without increasing network traffic. In one embodiment, the user station may determine which code segments constitute essential or key code segments by recording page faults in a miss table of the user station. The most frequently accessed pages can then be determined for storing in local memory. To maintain consistency of software when the operating system or an application program is revised or updated, one embodiment of the invention clears the key code segments from all local non-volatile storage devices when an operating system or application program is newly installed on one of the servers.

In another embodiment, network traffic is reduced by installing a program on the user station and the data server. When an application is invoked by the user station and the user begins to modify data, the program records the changes that are made to the data file locally in a local change file. Periodically the local change file is transferred to the data server, where the local changes are incorporated into a master change file on the data server. In one embodiment, the local change files are transferred to the appropriate server after a predetermined period of time or after a specified number of changes have been made to the data file. When the user ultimately exits the program or saves the data, the server program reads the master change file and implements those changes to the data file. By using change files that record only changes to an existing database, this embodiment reduces network traffic by requiring only small portions of the data file to be transferred across the network and by distributing the traffic that is sent across the network over time.

### BRIEF DESCRIPTION OF THE DRAWINGS

Other objects and advantages of the invention will become apparent upon reading the following detailed description and upon reference to the accompanying drawings in which:

FIG. 1 illustrates a data processing network according to one embodiment of the present invention;

FIG. 2 is a block diagram illustrating selected features of a device of the network of FIG. 1;

FIG. 3 is a block diagram illustrating selected features of the data processing system of FIG. 1 emphasizing maintaining key code segments local to the user station to reduce network traffic; and

FIG. 4 is a block diagram illustrating selected features of the data processing system of FIG. 1 emphasizing the use of change files to reduce network traffic according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

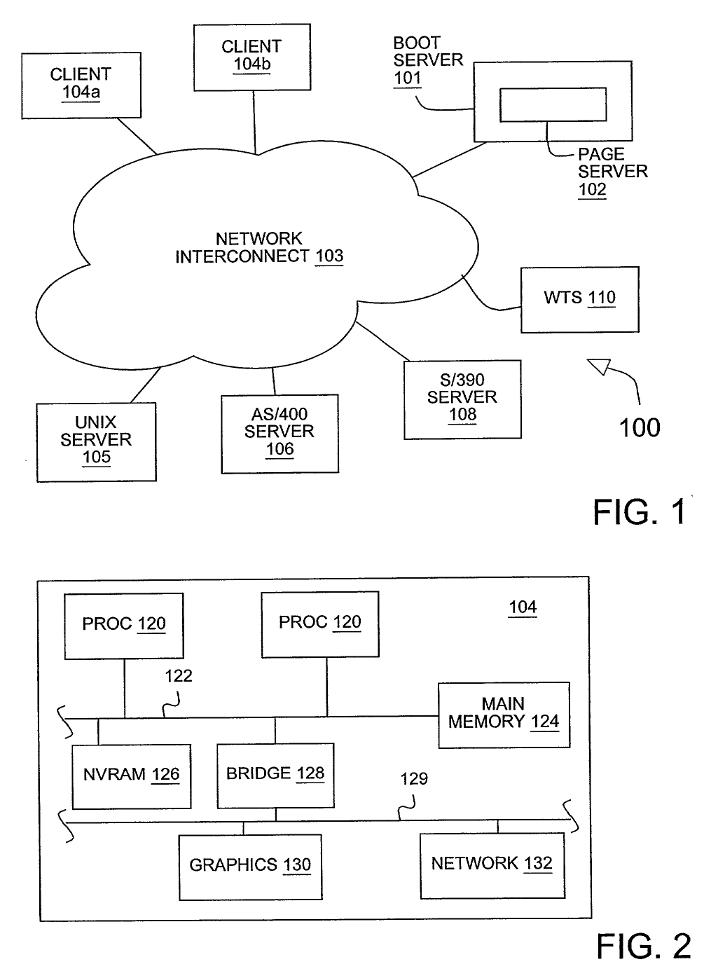

Turning now to the drawings, FIG. 1 depicts an exemplary computer network 100 in which the present invention may be employed advantageously. In the depicted embodiment, network 100 includes multiple data processing devices that are interconnected by a network interconnect 103. Network 100 and network interconnect 103 may be implemented with any of a variety of suitable topologies, physical media, and data communications protocols. In one common example, network 100 and interconnect 103 form a local area network (LAN) that supports the transmission control protocol/internet protocol (TCP/IP) suite of protocols and applications. TCP/IP provides the foundation and framework for many computer networks including the Internet. TCP/IP is extensively documented in a variety of publications including M. Murhammer et al., TCP/IP Tutorial and Technical Overview, available online at www.redbooks.ibm.com (#GG24-3376-05) and incorporated by reference herein.

Network 100 includes a variety of data processing device types including a boot server 101 that may include a corresponding code page server 102. Network 100 is shown as further including multiple user stations, also referred as clients or thin clients 104a and 104b (generically or collectively referred to herein as client(s) 104). User stations 104 refer generally to a class of low cost data processing devices that depend upon a remote host to supply their code pages for normal operation. Referring briefly to FIG. 2, user station 104 may be designed with one or more processors 120 that are connected to a main memory or system memory 124 over a system bus or memory bus 122. Processors 120 may be implemented with any of a variety of microprocessors such as the PowerPC® processor from IBM Corporation.

Typically, user station 104 includes a non-volatile storage device such as a ROM, EEPROM, or flash card, that may contain sufficient code to enable to user station 104 to download an operating system from a network server such as boot server 101. User station 104 may also include a bus bridge 128 that couples system bus 122 to a peripheral bus 129. A peripheral bus, such as a Peripheral Components Interface (PCI) bus, connects various peripheral devices to system bus 129. The peripheral devices may include a graphics adapter 130 and a network adapter 132 through which user station 104 is connected to network 100.

User stations 104 may be implemented with any of a variety of network station systems such as the NetVista™ line of thin client devices from IBM Corporation. The depicted embodiment of Network 100 further includes application server systems including, as examples, a Unix server such as an RS/6000® server 105, a business server such as an AS/400® server 106, and an enterprise server such as an S/390® server 108, all available from IBM Corporation. Network 100 may further include a Windows Terminal Server (WTS) 110 from Microsoft in combination with a software interface that enables the user station to access WTS 110. Although network 100 is illustrated as including a specific combination of network devices, those knowledgeable in the field of data processing networks will appreciate that network 100 may incorporate various combinations of the devices indicated in FIG. 1 and may include a variety of additional network devices not illustrated without departing from the spirit and scope of the disclosed network.

In one embodiment, network 100 supports a Dynamic Host Communication Protocol. DHCP is a network protocol that enables a properly configured server (a DHCP server) to automatically assign an Internet protocol (IP) address to the TCP/IP stack of a client computer 104. A DHCP server assigns user station 104 IP addresses dynamically from a pre-defined range of IP addresses for the network. User stations 104 configured to use DHCP for IP assignment do not need to have a statically assigned IP address and generally do not need to have addresses configured for a Domain Name Server (DNS), which can also be dynamically assigned by the DHCP server.

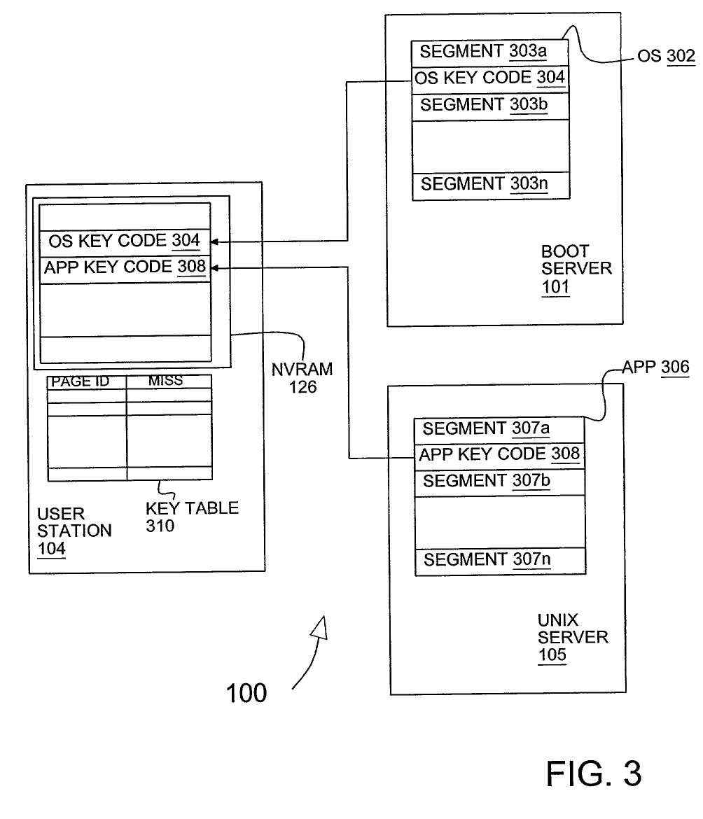

Turning now to FIG. 3, selected features of data processing network 100 according to one embodiment of the present invention are depicted to illustrate a method and system for reducing traffic in the computer network. The depicted embodiment illustrates one of the user stations 104, a boot server 101, and an application server, namely, a Unix server 105.

Typically, user station 104 lacks a persistent mass storage device such as a hard disk. User station 104 must, therefore, download operating system code and application code via the network to function. Each time user station 104 is booted, all or a portion of the operating system code in a conventional network is transferred to the system memory of user station 104. The transfer of operating system code from the boot server to the user station can result in significant network traffic. If multiple users are logging on simultaneously, the resulting network traffic can negatively impact system performance.

After user station 104 downloads an operating system, the user typically invokes one or more application programs to perform some desired task. When an application program is invoked in the conventionally designed network, all or portions of the application program are transferred from an application server to the user station via the network thereby resulting in network traffic. If multiple users are invoking various applications via the network, network performance may again deteriorate.

To address the network traffic resulting from software that is distributed across the network, the user station 104 according to one embodiment of the present invention is configured to store selected portions of software locally in a non-volatile storage device such as NVRAM 126. The portions of software that are selected for storage in NVRAM 126 are preferably the portions of operating system and application code that are most frequently invoked by the user station 104. With the most frequently accessed portions of code stored locally on user station 104, packet traffic in data processing network 100 is reduced because user station 104 can retrieve necessary code from its own local storage.

As depicted in FIG. 3, boot server 101 includes an operating system 302 that is used by user station 104. Operating system 302 may include one or more code segments 303a, 303b, etc. (generically or collectively referred to herein as code segments 303) including a key code segment 304. Each code segment 303 of operating system 302 may be stored as a single file in a directory of boot server 101.

Typically, user station 104 will not require and will not have sufficient system memory to store the entire operating system 302 locally. Instead, user station 104 in a conventional network will download code segments 303 of operating system 302 as the code segments are needed. Each time a code segment 303 is downloaded, network traffic is created as a copy of code segment 303 is transferred from boot server 101 to user station 104. User station 104 will typically invoke the various code segments 303 non-uniformly. In other words, some code segments 303 of operating system 302 are likely to be invoked relatively frequently whereas other code segments 303 are likely to be rarely, if ever, invoked by user station 104.

Data processing network 100 according to one embodiment of the present invention reduces network traffic by storing frequently invoked code segments 303 of operating system 302 locally in non-volatile storage of user station 104. When user station 104 encounters a page fault indicating that a portion of a requested a code segment 303 is not in the system memory of user station 104, the user station will determine, perhaps from a page table, if the desired code segment is stored locally in NVRAM 126 of user station 104. If the desired code segment is stored locally, user station 104 can transfer the desired page(s) to its system memory without inducing any network traffic.

Similarly, the NVRAM 126 of user station 104 can store portions or code segments 307 of an application program 306 that resides on a server such as Unix server 105. As depicted in FIG. 3, application program 306 includes multiple code segments 307 including a key code segment identified by reference numeral 308. The key code segment 308 identifies a code segment 307 of application program 306 that is frequently accessed by user station 104 based upon specified criteria. When user station 104 is executing application 306, various portions of code segments 307 are stored in the system memory of user station 104. If, during execution of the application 306, a page fault or other similar interrupt occurs, user station 104 will determine from a page table (not shown) if the missing page is available in NVRAM 126. If the missing code is available locally from NVRAM 126, user station 104 will transfer the missing code from NVRAM 126 to system memory directly, thereby minimizing network traffic and potentially improving performance.

In one embodiment, each user station 104 of network 100 is configured to determine the pages or codes segments that are designated as key code segments. Thus, the NVRAM 126 of each a first user station 104 may contain different code segments than the NVRAM 126 of a second user station. User stations 104 may determine which code segments are defined as key code segments by logging page faults. In this embodiment, each user station 104 may include a key table 310 that indicates the number of page faults that occur for various memory pages or code segments. Key table 310 may be ordered by the number of page faults such that the pages or code segments that have been accessed most frequently are easily identified. User station 104 may periodically and automatically update the key code segments 304 and 308 that are stored in NVRAM 126 based on predetermined criteria such as the contents of key table 310.

If a new revision of the operating system 302 or the application program 306 is installed on the network servers, it is desirable to maintain software consistency throughout network 100. In one embodiment, this consistency may be enforced by automatically erasing the key code segments from the NVRAM 126 of each user station 104 whenever an application or program is installed. In this manner, each user station 104 will be forced to download all of its software from the servers thereby ensuring software consistency throughout the network.

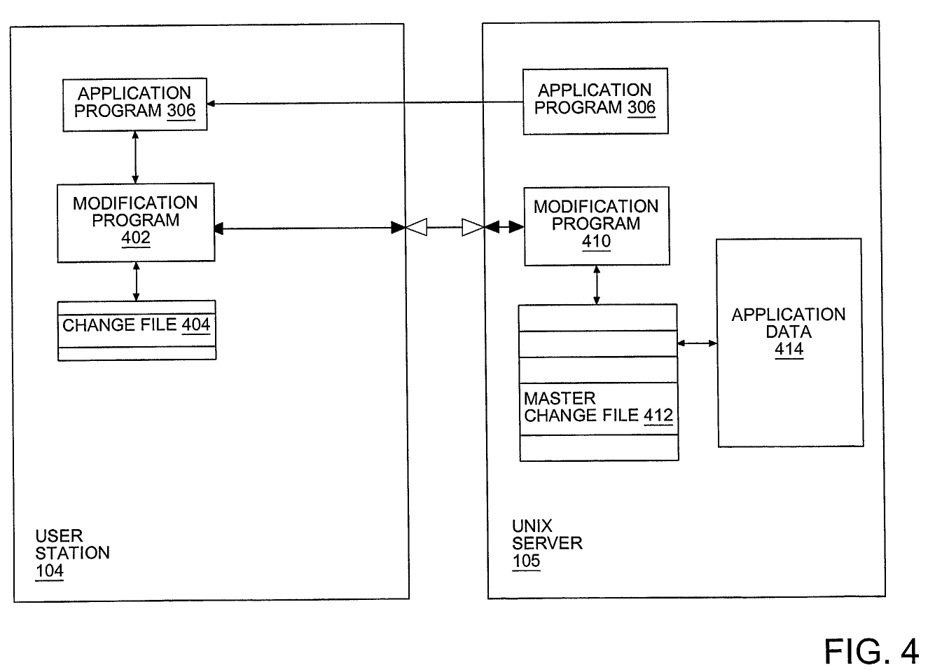

The components of the invention described above with respect to FIG. 3 may be effective in reducing network traffic caused by frequent page misses or software downloads. Turning now to FIG. 4, selected features of an embodiment of the invention are depicted emphasizing a method of reducing network traffic due to modifications of data files that are located on an application server. Generally speaking, each user station is configured to generate a change file that reflects the changes that are made to a data file. Periodically, these relatively small change files may be transmitted to the application server, where they are incorporated into a master change file. When the user completes his or her modifications, the application server incorporates the changes reflected in the master change file into the data file. By recording modifications to a data file as a sequence of changes and by periodically transmitting these changes to the server, the network traffic is reduced and distributed over time thereby potentially significantly reducing the peak traffic that is experienced on the network.

As depicted in FIG. 4, an application program 306 resides on an application server, Unix server 105, of network 100. When a user invokes the application, all or a portion of application program 306 is transferred via the network to user station 104. (As discussed above, portions of application program 402 may be stored locally on a non-volatile memory of user station 104). A user will typically invoke an application program to modify data. In a typical network environment, the application data is stored in a data file 414 on a data server that is remote to user station 104. In the depicted embodiment Unix server 105 serves as the application server as well as the data server.

Rather than transferring the entire data file 414 (or a large portion of it) across the network to the server, the invention according to the embodiment depicted in FIG. 4 reduces network traffic by focusing on the changes to the data that are made by the user. Initially, when an application program 306 is invoked by the user, all or a part of the application is transferred from the application server to the user station 104 across the network. The application program 306 on user station 104 is then used to create/edit data.

In a conventional network implementation, network traffic is unnecessarily wasted as large portions of data files are transferred back and forth between user station 104 and the data server 105. In the embodiment of the present invention depicted in FIG. 4, however, network traffic is reduced by recording and transmitting changes that are made to the data rather than transmitting the data itself.

Referring back to FIG. 4, the application program 306 on user station 104 permits the user to make changes to an application data file 414 that is stored in a data server such as Unix server 105. Initially, a portion of data file 402 may be downloaded to user station 104. The user may then invoke application program 306 to modify the data. A modification program 402 residing on user station 104 is configured to record the changes made to the data by the user. In one embodiment, modification program 402 may record changes to the data by recording keystrokes at user station 104. In this embodiment, modification program 402 is preferably configured to filter keystrokes that are entered when application program 306 is active from keystrokes entered by the user when other applications are active.

Modification program 402 on user station 104 is configured to create a change file 404 on user station 104 that stores the changes to the data that are entered by the user. Modification program 402 periodically transmits change file 404 to data server 105 across the network. In one embodiment, modification program 402 transmits change file 404 after a predetermined or user specified time interval. In another embodiment, modification program transmits change file 402 after a predetermined or user specified number of changes have been made to the data.

Each time modification program 402 transmits change file 404 across the network to the data server 105, the changes are incorporated into data file 414. In the depicted embodiment, a modification program 410 residing on data server 105 receives each change file 404. The data server modification program 410 may be configured to incorporate each change file 404 received from user station 104 into a master change file 412. The master change 412 thus reflects all changes that a user makes to data file 414 during a given editing session.

When the user indicates that no additional changes to data file 414 are required, such as by closing application program 316 or “saving” the data, modification program 410 is configured to modify application data file 414 based on the contents of master change file 412. In an embodiment where each change file 404 created by modification program 402 indicates a sequence of key strokes, modification program 410 may modify application data file 414 by effectively opening application program 306 and applying the recorded sequence of keystrokes to the data file application program 414. In this embodiment, the change files 404 and 412 serve as recordings of a specific key stroke sequence and the modification program 410 modifies the application data file 414 by “playing back” the recorded key stroke sequence.

It will be appreciated that the change file 404 transmitted across the network is frequently small relative to application data file 414. As an example, application data file 414 may comprise a database of customers, creditors, suppliers, employees, etc. Occasionally, the database must be updated to add, delete, or modify one or more records in the database. Under these circumstances, it is reasonable to assume that the changes to data file 414 are relatively minor in scope compared to the size of the file 414. By transmitting the change file 404 across the network rather than storing a local copy of data file 414 on user station 414, modifying the local data file, and transmitting the modified data file across the network, network bandwidth is conserved thereby potentially improving network performance. Moreover, by transmitting a sequence of change files 404 across the network at periodic intervals, the data that is transmitted across the network is distributed over time thereby beneficially reducing the peak bandwidth required to accommodate the modification of data file 414.

The methods of the present invention are capable of being implemented as a program product (i.e., computer software) in a variety of forms, and that the present invention applies equally regardless of the particular type of computer readable media used. Examples of computer readable media include: nonvolatile, hard-coded type media such as read only memories (ROMs) or erasable, electrically programmable read only memories (EEPROMs), recordable type media such as floppy disks, hard disk drives and CD-ROMs, and transmission type media such as digital and analog communication links.

It will be apparent to those skilled in the art having the benefit of this disclosure that the present invention contemplates a method and system for reducing packet traffic and peak bandwidth requirements in a data processing network. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of operating a computer network comprising:
invoking a server program residing on a network server from a network user station;
retrieving a data file from a network server to a network user station;
recording changes made to the data file in a change file located in user station storage;
upon completing the changes, transferring the change file to the network server; and
modifying the data file on the network server based on the contents of the change file.

2. The method of claim 1, further comprising periodically transferring the contents of the change file to the network server.

3. The method of claim 2, further comprising accumulating the contents of the periodically transferred change files in a master change file on the network server.

4. The method of claim 3, wherein modifying the data file on the network server comprises modifying the data file based on the contents of the master change file.

5. The method of claim 1, further comprising:
determining portions of the server program that are frequently invoked by the user station;
copying the determined portions of the server program from the network server to local storage of the network user station; and
upon subsequently invoking one of the determined portions, using the locally stored copy of the server program.

6. The method of claim 5, wherein determining frequently invoked portions of the server program includes recording page misses in a table in the user station storage.

7. The method of claim 5, wherein copying the determined portions of the server program to local storage comprises copying the determined portions in a non-volatile storage device of the user station.

8. A data processing network, comprising:
a network server including processor and storage wherein the network server storage contains a server program code and data file code; and
a network user station including processor and storage connected to the network server via a network medium;
wherein the user station includes code for invoking the server program, retrieving the data file from a network server, recording changes made to the data file in a change file located in user station storage, and transferring the change file to the network server upon completing the changes; and
wherein the network server includes code for modifying the data file on the network server based on the contents of the change file.

9. The system of claim 8, wherein the user station further comprises code for periodically transferring the contents of the change file to the network server.

10. The system of claim 9, wherein the server further comprises code for accumulating the contents of the periodically transferred change files in a master change file on the network server.

11. The system of claim 10, wherein code for modifying the data file on the network server comprises code for modifying the data file based on the contents of the master change file.

12. The system of claim 8, further comprising:
user station code for determining portions of the server program that are frequently invoked by the user station;
user station code for copying the determined portions of the server program from the network server to local storage of the network user station; and
code for using the locally stored copy of the server program upon subsequently invoking one of the determined portions.

13. The system of claim 12, wherein the code for determining frequently invoked portions of the server program includes code for recording page misses in a table in the user station storage.

14. The system of claim 12, wherein code for copying the determined portions of the server program to local storage comprises code for copying the determined portions in a non-volatile storage device of the user station.

15. A computer program product residing on a computer usable medium for reducing network traffic in a computer network, the computer program product comprising:
code means for invoking a server program residing on a network server from a network user station;
code means for retrieving a data file from a network server to a network user station;
code means for recording changes made to the data file in a change file located in user station storage;
code means for transferring the change file to the network server upon completing the changes; and
code means for modifying the data file on the network server based on the contents of the change file.

16. The computer program product of claim 15, further comprising periodically transferring the contents of the change file to the network server.

17. The computer program product of claim 16, further comprising accumulating the contents of the periodically transferred change files in a master change file on the network server.

18. The computer program product of claim 17, wherein modifying the data file on the network server comprises modifying the data file based on the contents of the master change file.

19. The computer program product of claim 15, further comprising:
determining portions of the server program that are frequently invoked by the user station;
copying the determined portions of the server program from the network server to local storage of the network user station; and
upon subsequently invoking one of the determined portions, using the locally stored copy of the server program.

20. The computer program product of claim 19, wherein determining frequently invoked portions of the server program includes recording page misses in a table in the user station storage.

21. The computer program product of claim 19, wherein copying the determined portions of the server program to local storage comprises copying the determined portions in a non-volatile storage device of the user station.
